(19) United States
(12) Patent Application Publication
(10) Pub. No.: US 2010/0030519 A1
(43) Pub. Date: Feb. 4, 2010

(54) System for Real-Time Object Damage Detection and Evaluation

(76) Inventors: Jarrell D. Collier, Sherman Oaks, CA (US); Michael P. Davenport, Camarillo, CA (US); H.K. John Armenian, Sherman Oaks, CA (US)

Correspondence Address: Arent Fox LLP, 555 West Fifth Street, 48th Floor, Los Angeles, CA, 90013, US

(21) Appl. No.: 12/184,063

(22) Filed: Jul. 31, 2008

(51) Int. Cl. G06F 17/18

(52) U.S. Cl. 702/181

(57) ABSTRACT

A method for determining a probability of damage by an object to be evaluated, including propagating a kinematic state of the object to be evaluated; determining a plurality of probabilities of damage; determining whether each probability of damage is feasible and creating a set of probabilities of feasible damage for each probability of damage; and determining the mean and variance of probability of feasible damage based on the set of probabilities of feasible damage. A system and apparatus for performing the method is also disclosed.

### BACKGROUND

I. Field

The following description relates generally to real-time probabilistic predictions for future events and conditions as used for resource deployment and planning in defense and security applications, and, more particularly, to a system for real-time object damage detection and evaluation.

II. Background

There are numerous application domains where a need exists to determine, based on real time sensor and detection, a probabilistic determination of some future event or condition. One area that needs to be addressed is predicting some future event or condition based on defected data from sensors or other input sources (also referred to as current state information), where the current state information has some measure of uncertainty associated with it.

In security and defense applications there are at least two primary functions that require probabilistic prediction. One primary function is an analysis of the probability that an object to be intercepted can be successfully intercepted using the deployment of a selected defensive resource. For example, there may be multiple defensive resources that can be deployed to intercept the object to be intercepted. Each can be evaluated on its own to determine the probability of a successful intercept. In addition, combinations of thereof can be evaluated as well.

The second primary function that requires probabilistic prediction is the evaluation of a threat, such as an object to be evaluated, to determine the nature of the threat. For example, part of the determination of the nature of the threat is the potential damage the object to be evaluated may cause to a threatened asset. In defense

applications such as missile defense it is possible to learn more about the nature of the threat, especially in the discrimination process: sometimes it is possible to estimate the size of the various objects deployed from a threat missile, or even to obtain a radar image of the threat, and to estimate how it is spinning or tumbling and other kinematic behavior. All these determinations would provide various evaluations of the object.

The solutions to addressing these two functions take on different forms depending upon the source of the uncertainty in each function. In one instance, for systems that operate in real-time where, for example, information is gathered about a real, ongoing situation and processed as it is received; the primary source of uncertainty is generated by a sensor or sensor system that provides kinematic state information and possibly other types of information about an object to be evaluated. For example, sensors can be based on radar, infrared, image, acoustic, or anything that is capable of providing a measurement from which kinematic state information can be derived. The error can be due to electrical or mechanical noise generated by the sensor: discretization (approximation) error due to sampling, and, in some cases, distortion of the signal to do the medium through which the signal travels.

One important measure of performance of any system that operates under a real-time environment is the ability to effectively balance the tradeoff between accuracy of the solution and the processing resources required to obtain the solution. For example, due to the real-time nature of the situation under which the system has to operate, the system does not have unlimited processing time nor resources. Accuracy achieved at the cost of processing resources is undesirable in the system. On the opposite extreme, a complete sacrifice of accuracy is also undesirable as other down-stream resources will be wasted if the solution is not accurate.

Consequently, it would be desirable to address one or more of the deficiencies described above.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to various aspects, the subject innovation relates to systems and/or methods that provide a method for determining a probability of damage by an object to be evaluated, including propagating a kinematic state of the object to be evaluated; determining a plurality of probabilities of damage; determining whether each probability of damage is feasible and creating a set of probabilities of feasible damage for each probability of damage; and determining the mean and variance of probability of feasible damage based on the set of probabilities of feasible damage.

In another aspect, a system for real-time determination of damage probability for an object to be evaluated to a target includes an object information storage unit configured to store a kinematic state of the object to be evaluated; a damage probability determination unit configured to determine a plurality of probabilities of damage for the object to be evaluated; and a variance and means determination unit configured to determine the mean and variance of probability of damage based on the set of probabilities of damage.

In yet another aspect, a system for determining a probability of damage by an object to be evaluated includes means for propagating a kinematic state of the object to be evaluated; means for determining a plurality of probabilities of damage; means for determining whether each probability of damage is feasible and creating a set of probabilities of feasible damage for each probability of damage; and means for determining the mean and variance of probability of feasible damage based on the set of probabilities of feasible damage.

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed and the described aspects are intended to include all such aspects and their equivalents.

### BRIEF DESCRIPTION OF THE DRAWINGS

FIG. 1 is a system diagram illustrating a system for real-time damage detection and evaluation of an object to be evaluated, configured in accordance with one desired approach.

FIG. 2 is a flow diagram illustrating the operation of the real-time object damage and evaluation system to determine a conditional mean and variance of the probability of the kinematic state of the object to be evaluated.

FIG. 3 is a flow diagram illustrating a probabilistic approach for determining probability of damage caused by an object to a point asset to be evaluated in the real-time object damage detection and evaluation system.

FIG. 4 is a flow diagram illustrating a probabilistic approach for determining probability of damage for an object to an area asset be evaluated in the real-time object damage and evaluation system.

FIG. 5 is a block diagram of a computer system usable in the real-time object damage detection and evaluation system of FIG. 1.

### DETAILED DESCRIPTION

A system providing a real-time probabilistic prediction mechanism is described herein that is adapted to the address the probabilistic implementations discussed above. The described mechanism provides a better balance between the tradeoffs of accuracy versus computational resources than the prior art, which makes it suitable for real-time applications, and in some cases offers a simpler path to implementation as well. In one exemplary embodiment, the real-time probabilistic prediction mechanism is implemented as a system for real-time object damage detection and evaluation. Specifically, the system provides a determination of a probability of damage that may be caused by an object to be evaluated.

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

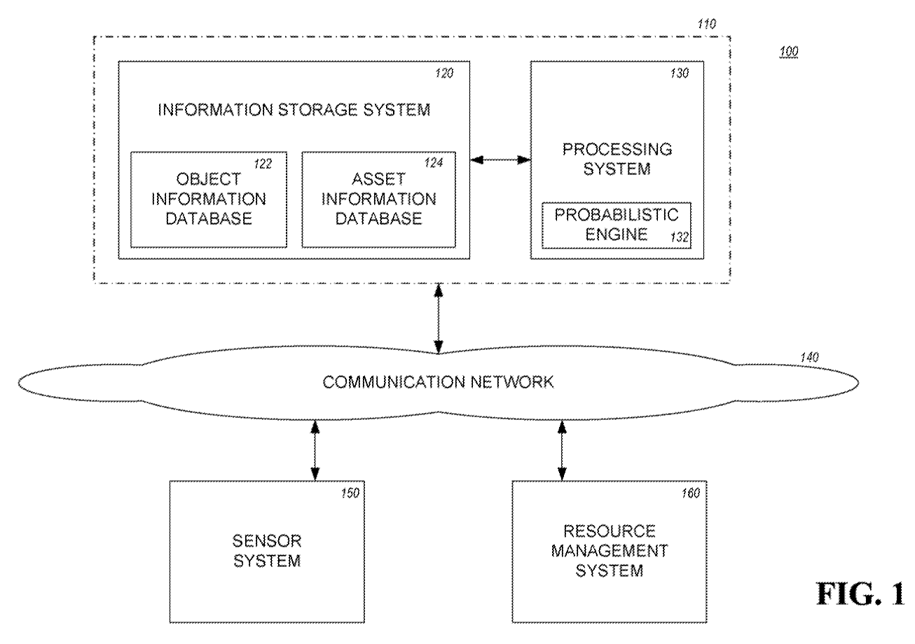

FIG. 1 illustrates a system diagram in which a real-time object damage and evaluation system 100 may be implemented in accordance with one aspect of the present disclosure, including a server system 110 having a processing system 130 that includes a probabilistic engine 132. The processing system 130 is coupled to an information storage system 120 that includes an object information database 122 for storing information related to objects to be evaluated, and an asset information database 124 for storing information related to assets. A sensor system 152 is coupled for communicating with the server system 110 through a communication network 140. Further, a resource management system 160 is coupled to the communication network 140 for managing resources based on the information received from the various systems contained therein.

The probabilistic engine 132 interacts with other application software on the processing system 130 and the information storage system 120 to perform the probabilistic determination as described herein, including processing information received from the sensor system 150. The probabilistic engine 132 may access and present information from, as well as store information into, the information storage system 120. A user, using a client user interface (not shown), interacts with the server system 110 and the resource management system 160. Multiple server systems and clients, as well as other computer systems (not shown) may also be coupled to the server system 110. Further, although the server system 110 is presented as two systems; with the processing system 130 residing on one system, and the information storage system 120 (including the object damage information database 122) residing on another system. the probabilistic functionality provided herein may be deployed using a single server system or may be spread over multiple systems.

In the illustrated example, the communications network 140 represents a variety of networks that may include one or more local area networks as well as wide area networks. The functionality provided by the information storage system 120, the processing system 130, as well as by any other computer systems necessary in the probabilistic system may be implemented using a computer system having the characteristics of the computer system described further herein. If should be noted, however, that the specific implementation of the computer system or systems used to describe the present system is not to be limiting unless otherwise specifically noted. For example, the functionality provided by the information storage system 120 and the processing system 130 may be combined in one computer system. Further, the functionality provided by the information storage system 120 and the processing system 130 may be distributed over several computer systems.

### Description of Fundamental Concepts

Real-time probabilistic prediction of future events and conditions is important and useful for systems used lo predict and intercept certain objects. Typically, these systems are designed to address probabilistic situations of the following form:

A predicted event A is affected by a random vector X, which represents the kinematic state of an object to be evaluated at some time, and by a vector Y, which represents a set of random variables. The kinematic state of the object to be evaluated has been observed up to the current time by a sequence of observations Z=z, but the aforementioned random variables Y cannot be observed. Furthermore, Y and Z are independent. The challenge is the ability to determine, in real time, the conditional mean μ_{A} and variance σ_{A}² given the observations Z=z, of the conditional probability of A, given the random vectors X and Y:

μ_{A}=E(P(A|X, Y)|Z=z),

and

σ_{A}²=Var(P(A|X, Y)|Z=z).

However, this determination may be reduced to a form that is more suitable for real lime processing. Because Y and Z are independent of each other, Y does not directly affect the determination, so the determination reduces to:

μ_{A}=E(P(A|X)|Z=z),

and

σ_{A}²=Var(P(A|X)|Z=z),

where the effect of Y has been integrated into the conditional probability P(A|X), which cart be modeled offline. Thus, only the conditional mean and variance of P(A|X), given the observations Z=z, must be determined in real time.

The above determination can be approached in a different fashion that leads to an easy generalization. Let 1_{A} be a random variable, where:

$${I}_{A} = \{ \begin{matrix}1 & if event A occurs \\ 0 & otherwise\end{matrix} \} .$$

The conditional expectation of the random variable 1_{A} is the conditional expectation of the event A:

E(1_{A}|X)=P(A|X).

The simplified conditional mean and variance determinations described above is equivalent to

μ_{A}=E(E(1_{A}|X)|Z=z),

and

σ_{A}²=Var(E(1_{A}|X)|Z=z).

In general, the challenge is to determine the conditional mean and variance given Z=z, of the conditional expectation of a random variable W at a future time given X and Y. As above, this determination reduces to determining:

μ_{W}=E(E(W|X)|Z=z),

and

σ_{W}²=Var(E(W|X)|Z=z).

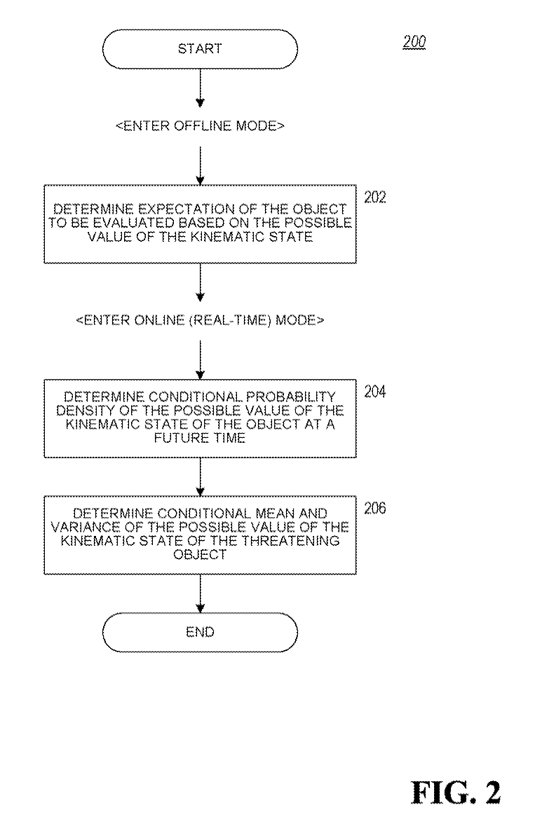

An approach 200 for determining the conditional mean and variance given the observations Z=z up to the current time has two parts, as illustrated in FIG. 2. In step 202, a function f is constructed in an offline mode that approximates the conditional expectation:

f(x)≈E(W|X=x),

where in tins expression, x is a possible value of the kinematic state of the object to be evaluated at the future time of interest.

Then, during an online mode of the process 200, the conditional probability density function p_{X|Z}(x|Z=z) of X at the future time given the observations Z=z up to the current time is determined in step 204. Ordinarily, both X and Z have Gaussian distributions, so this conditional probability density function is also Gaussian. In one approach, the conditional probability density function can be determined using a Kalman-type filter based on the work of Dr. Rudolf Emil Kalman.

In step 206, the conditional mean μ_{W} and variance σ_{W}² given the observations Z=z are determined:

μ_{W}=∫f(x)p_{X|Y}(x|z)dx,

and

σ_{W}²=∫(f(x)−μ_{W})² p_{X|Z}(x|z)dx.

The determination of the conditional mean and variance requires numerical integration techniques, because they are defined by integrals. The exemplary approaches to probabilistic object detection and interception described herein utilize an unscented transform to perform the numerical integration, and it is described in the following section.

### Unscented Transform

In general, the unscented transform approximates the mean and variance of a random variable Y=f(X) in terms of the mean and covariance of X, where X is an n-dimensional random vector and f is a nonlinear function. For purposes of describing the exemplary approach using the unscented transform, the conditioning on Z=z will not be referred to in the following sections.

In one exemplary approach, the approximation requires evaluating the function at 2n+1 points sᵢ, i=−n, . . . ,n, referred to either as weighted samples or sigma points, and determining corresponding weights wᵢ, i=−n, . . . ,n. Thus, if:

yᵢ=f(sᵢ), i=−n, . . . ,n,

then the means of Y is:

$$E ( Y ) \approx {\sum }_{i = - n}^{n} {w}_{i} {y}_{i} ,$$

and the variance of Y is:

$$Var ( Y ) \approx {\sum }_{i = - n}^{n} {{w}_{i} ( {y}_{i} - E ( Y ) )}^{2} ,$$

where the sigma point sₒ=E(X), the mean of X. The other sigma points lie on a covariance ellipsoid determined by the covariance of X, centered at the mean of X.

It is possible to adjust the size of the covariance ellipsoid by choosing a scale factor α. When α=1 (i.e., when the scale factor is equal to 1), the method is said to be unsealed. When α>1 (i.e., when the scale factor is greater than 1), the ellipsoid is larger, and when α<1 (i.e., the scale factor is less than 1), it is smaller. Further, when α≠1 (the scale factor is not equal to 1), the variance has an additional term:

$$Var ( Y ) \approx {\sum }_{i = - n}^{n} {{w}_{i} ( {y}_{i} - E ( Y ) )}^{2} + ( 1 - {α}^{2} ) ( {y}_{0} - {EY}^{2} ) .$$

To determine the weights, an unsealed weight wₒ₉ is first chosen for the center of the ellipsoid. The value

$${w}_{00} = \frac{1}{3}$$

is used in the preferred approach. Then set:

$${w}_{0} = \frac{{w}_{00} + {α}^{2} - 1}{{α}^{2}}$$

$$and$$

$${w}_{1} = \frac{1 - {w}_{00}}{2 n {α}^{2}} for i = 1 , … n and i = - 1 , … , - n$$

To determine the sigma points, first determine the factorization of the covariance of X:

Cov(X)=CC^{T},

where C is lower triangular and the factorization is performed using the approach of André-Louis Cholesky, Let c₁, . . . ,cₙ be the column vectors of the matrix C, so that:

C=[c₁C₂ . . . cₙ],

then set:

sₒ=E(X),

sᵢ=sₛ+αcᵢ for i=1, . . . ,n

and

sᵢ=sₒ−αcᵢ for i=−1, . . . ,−n.

The mean and variance of Y may then be determined as described above.

In an aspect, the real-time object damage detection and analysis system 100 is configured to predict the potential effect of an object to be evaluated. For example, let W be the value of a defended asset that would be damaged by an object to be evaluated if the object to be evaluated is not engaged; X be the kinematic state of the object to be evaluated at the time it is predicted to reach the defended asset; Y be the vector of other random variables that affect the damage done by the object to be evaluated, such as the capability of the object to be evaluated for damage and the ability of the asset to resist damage; Z be the sequence of sensor observations of the kinematic state of the object to be evaluated up to the current time; and z be the corresponding sequence of actually observed values of Z. As discussed above, in one approach the conditional expectation of damage E(W|X=x) is modeled offline as a function of the possible values x of the kinematic state X of the object to be evaluated at the time it is predicted to reach the defended asset, integrating the effects of the unobservable random variables Y. Correspondingly, the conditional mean and variance of E(W|X=x) are determined in real time.

In an aspect, all defended asset have an asset value vₐₛₛₑₜ. These asset values vₐₛₛₑₜ are typically assigned by a user based on the specific implementation needs of the desired evaluation. The mean damage value for an object to be evaluated-defended asset pair is the expected loss of defended asset value if the defended asset is damaged because the object to be evaluated is not intercepted. In one aspect, where the real-time object damage and evaluation system 100 is being deployed in a defense application, an example of the object to be evaluated is an explosive weapon. In this application, one objective is to determine the mean and variance of the damage value caused by the object to be evaluated.

In general, there are two types of defended assets: point assets and area assets. Point assets have areas, but the area of any point asset is small as compared to the area of effect, or damage radius, of the object to be evaluated, and is considered to be either destroyed by the object to be evaluated or not. In contrast, area assets are large enough compared to the damage radius of the object to be evaluated that an area asset can be partially destroyed. For example, if the object to be evaluated is an explosive weapon carried by a missile, then a structure such as a building is a point asset and a block on which the structure sits is an area asset. It should readily follow that whether an asset is classified as a point or area asset is dependant on the area of effect of the object to be evaluated. Further, in some instances, an asset may be divided into multiple asset types.

In an aspect, for a point asset, the mean damage value for an object to be evaluated-defended asset pair is defined to be the asset value of the defended asset vₐₛₛₑₜ multiplied with the probability that, the object to be evaluated will destroy the defended asset if the objected to be evaluated is not intercepted. This probability is determined as the integral of a damage function with respect to the probability density ground impact point of the object to be evaluated:

$${P}_{damage} ( {r}_{asset} ) = {\int }_{{ℝ}^{2}} D ( {r}_{asset} , {r}_{impact} ) {p}_{impact} ( {r}_{impact} ) d {r}_{impact} ,$$

where P_{damage} is the probability that the object to be evaluated will destroy the defended asset if not intercepted; rₐₛₛₑₜ is the location of the point asset, r_{impact} is the ground impact point of the object to be evaluated; D is the damage function; p_{impact} is the probability density function of the ground impact point; and R² is the horizontal plane tangent to the Earth at the asset location. D(rₐₛₛₑₜ,r_{impact}) can be interpreted as the conditional probability that the object to be evaluated will destroy the point asset at rₐₛₛₑₜ, given that r_{impact} is the ground impact point of the object to be evaluated.

In an aspect, for an area asset, the mean damage value is defined to be the asset value of the defended asset vₐₛₛₑₜ multiplied with an expected fraction of the defended asset that the object to be evaluated will destroy if the object to be evaluated is not intercepted. The expected fraction is determined as the expected value of P_{damage} with respect to the uniform distribution over the asset region:

$${F}_{damage} ( A ) = \frac{1}{area ( A )} {\int }_{A} {P}_{damage} ( {r}_{asset} ) d {r}_{asset} ,$$

where, in this expression, F_{damage} is the expected fraction of the asset that the object to be evaluated will destroy if not intercepted; A is the region in the horizontal plane tangent to the Earth at the centroid of the region that is covered by the area asset; and for each point rₐₛₛₑₜ in the region; and P_{damage}(rₐₛₛₑₜ) is determined as it is for a point asset. If the expected fraction expression is expanded and change the order of integration, it becomes:

$$\begin{matrix}{F}_{damage} ( A ) = \frac{1}{area ( A )} {\int }_{A} [ {\int }_{{ℝ}^{2}} D ( {r}_{asset} , {r}_{impact} ) {p}_{impact} ( {r}_{impact} ) d {r}_{impact} ] d {r}_{asset} \\ = {\int }_{{ℝ}^{2}} [ \frac{1}{area ( A )} {\int }_{A} D ( {r}_{asset} , {r}_{impact} ) {p}_{impact} ( {r}_{impact} ) d {r}_{asset} ] d {r}_{impact} \\ = {\int }_{{ℝ}^{2}} [ \frac{1}{area ( A )} {\int }_{A} D ( {r}_{asset} , {r}_{impact} ) d {r}_{asset} ] {p}_{impact} ( {r}_{impact} ) d {r}_{impact}\end{matrix}$$

where, in the last line of this equation, the inner integral is the conditional expected fraction of the defended asset that will be destroyed, given the ground impact point of the object to be evaluated, if the object to be evaluated is not intercepted.

For both point and area assets, a challenge is to determine the mean and variance of the conditional expectation of a random variable, given the predicted kinematic state of the object to be evaluated. In this approach, only the position component of the predicted kinematic stale of the object to be evaluated is used. However, other components may be considered.

A previous approach for attacking this challenge was to simplify the damage function D and possibly the shape of the region A so that the mean can be either evaluated analytically or else compactly tabulated from offline determination without an evaluation of the variance.

Several possible damage functions have been proposed. In every case, the damage function D is simplified to be symmetric about the point rₐₛₛₑₜ; that is, D is of the form:

D(rₐₛₛₑₜ,r_{impact})=d(∥r_{impact}−rₐₛₛₑₜ∥),

where ∥r_{impact}−rₐₛₛₑₜ∥ is the Euclidean distance from rₐₛₛₑₜ to r_{impact}, and d(r) can be interpreted as the probability that the object to be evaluated will destroy the point asset, given that r is the distance from the impact point to the asset.

In addition, the probability density of the ground impact point of the object to be evaluated is assumed to be Gaussian:

p_{impact}(r_{impact})=φ(r_{impact}),

where φ is the two-dimensional Gaussian probability density with mean μ and covariance Σ.

The simplest case is the Gaussian damage function:

$${d}_{Gaussian} ( r ) = exp ( - \frac{{r}^{2}}{2 {b}^{2}} ) ,$$

where b is a constant chosen to approximate the damage radius of the object to be evaluated. For a point asset, the mean damage value can be evaluated analytically, provided that the mean ground impact point coincides with the location of the asset. For an area asset, the determination of the mean damage value can be reduced to integrating the probability density of the impact point over a circular disk, provided the area asset is essentially infinite with respect to the damage radius of the object to be evaluated.

It has been proposed that the most realistic case is the log-normal damage function:

$${d}_{log \text{-} normal} ( r ) = 1 - {\int }_{0}^{γ} \frac{1}{\sqrt{2 πβ}} exp ( - \frac{{ln ( r / α )}^{2}}{2 {β}^{2}} ) d r ,$$

where α and β are constants chosen to determine, indirectly, two distances r_{SK} and r_{SS} with the properties that the asset will be: destroyed with high probability for r≦r_{SK}; and safe with high probability for r≧r_{SS}. For a point asset, the mean damage value is currently evaluated with the use of a tabulation of the standard error function, provided that the mean ground impact point coincides with the asset location. For an area asset, the determination can be reduced in a way similar to the reduction for the Gaussian damage function.

The use of the Gaussian damage function has also been extended in other applications so that the mean damage value can be evaluated for both point and area assets with the use of tabulated auxiliary functions—even when the mean ground impact does not coincide with the asset location and even when the asset's region is a polygon. For a point asset, the auxiliary function is the standard Gaussian distribution function. For an area asset, the region is first decomposed into triangles and the double integral is analytically reduced to a single integral of a two-dimensional Gaussian density, for use in integrating a two-dimensional Gaussian density over a triangle.

One issue with the aforementioned approaches is that the damage function, and sometimes the asset region, is chosen for analytical convenience rather than physical realism. For example, the following damage evaluation is physically more realistic:

$$d ( r ) = \{ \begin{matrix}1 & 0 \leq r \leq {r}_{SK} \\ exp ( - \frac{{K}^{2}}{2} {( \frac{r - {r}_{SK}}{{r}_{SS} - {r}_{SK}} )}^{2} ) & {r}_{SK} \leq r < ∞\end{matrix} \} ,$$

where for damage function d(r), the damage value will be: 1 for r≦r_{SK}; arbitrarily close to 0 (depending on K) for r≧r_{SS}; and decrease smoothly for r_{SK}<r<r_{SS}. The constants r_{SK}, r_{SS}, and K would depend on the characteristics of the object to be evaluated and the defended asset. However, evaluation of this function is much more resource intensive based on current approaches and can not be handled by most current systems in real-time.

Another issue with existing approaches is that they do not provide a measure of confidence of the measured damage value, even though this determination and evaluation would be useful information. For example, the assignment of a plurality of resources for defending a set of assets may be maximized or altered based on the use of the variance of the damage value as the variance provides a measure of confidence of predicted mean damage value.

In an exemplary implementation, the real-time object damage and evaluation system 100 uses a probabilistic approach for object damage detection and evaluation. In an approach, the real-time object damage and evaluation system 100 provides an unbiased estimate of the mean damage value for an object to be evaluated/defended asset pair and, in addition, the variance damage value. It uses a physically realistic damage determination, such as the one described in the preceding section, and assumes that the probability density of the ground impact point of the object to be evaluated is a two-dimensional Gaussian density. Further, as discussed previously, the system numerically determines both the mean and the variance of damage value.

For a point asset, the real-time object damage and evaluation system 100 evaluates:

$${μ}_{damage} = {\int }_{{ℝ}^{2}} {v}_{asset} d ( ‖ {r}_{impact} - {r}_{asset} ‖ ) ϕ ( {r}_{impact} ) d {r}_{impact} , \\ and$$

$${σ}_{damage}^{2} = {\int }_{{ℝ}^{2}} {( {v}_{asset} d ( ‖ {r}_{impact} - {r}_{asset} ‖ ) )}^{2} ϕ ( {r}_{impact} ) d {r}_{impact} - {μ}_{damage}^{2} .$$

For an area asset, the real-time object damage and evaluation system 100 evaluates:

$${μ}_{damage} = {\int }_{{ℝ}^{2}} {v}_{asset} {F}_{damage} ( A \vert {r}_{impact} ) ϕ ( {r}_{impact} ) d {r}_{impact} , \\ and$$

$${σ}_{damage}^{2} = {\int }_{{ℝ}^{2}} {( {v}_{asset} {F}_{damage} ( A \vert {r}_{impact} ) )}^{2} ϕ ( {r}_{impact} ) d {r}_{impact} {μ}_{damage}^{2} , \\ where \text{:}$$

$${F}_{damage} ( A \vert {r}_{impact} ) = \frac{1}{area ( A )} {\int }_{A} d ( ‖ {r}_{impact} - {r}_{asset} ‖ ) d {r}_{asset} ,$$

is the conditional expected fraction of the asset that will be destroyed, given that the ground impact point is r_{impact}. In one aspect, the probabilistic approach taken by the real-time object damage and evaluation system 100 to perform these determinations involves the use of the unscented transform.

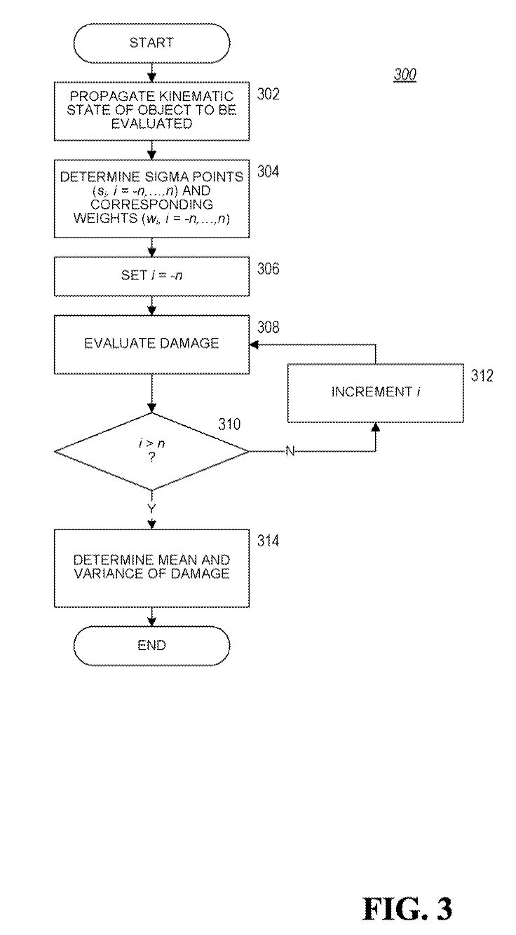

FIG. 3 illustrates a probabilistic process 300 that is an exemplary implementation of the probability determination performed by the real-time object damage and evaluation system 100 for a point asset, where, in step 302, the real-time object damage and evaluation system 100 propagates the mean kinematic state of the object to be evaluated from the most recent track report time to the predicted ground impact time. In one aspect, the propagation is performed using Runge-Kutta integration. In addition, the real-time object damage and evaluation system 100 propagates the error covariance of the kinematic state of the object to be evaluated and projects the mean and covariance of the kinematic state onto the horizontal plane tangent to the Earth at the asset's location. The result is the predicted mean μ and covariance Σ of the kinematic state of the object to be evaluated.

In step 304, the sigma points sᵢ, i=−n, . . . ,n and the corresponding weights wᵢ, i=−n, . . . ,n are determined.

For each sigma point sᵢ, a damage function is evaluated. Thus, in step 306, a counter is set to the value of −n, which will eventually be allowed to run through the value of n. In another approach, the counter is set to 1 and the process is allowed to loop through 2×n iterations.

Then, in step 308, the damage function:

sᵢ, yᵢ=d(∥sᵢ−rₐₛₛₑₜ∥),

is evaluated for a sigma point sᵢ.

In step 310, it is determined if all sigma points have been processed. In one approach, this is determined by checking the value of i to see if it is larger than the total number (2n+1) of sigma points. If more sigma points need to be processed, then operation continues with step 312, where the counter i is incremented. If all sigma points have been processed, then operation continues with step 314.

In step 314, the mean and variance of damage are determined.

The real-time object damage and evaluation system 100 utilizes the results from step 314 to determine the amount of damage that the point asset would sustain if the object to be evaluated is not intercepted. The variance provides a confidence measure of the accuracy of the mean value and, in other words, can indicate a level of certainty or uncertainty of the accuracy. For example, a small variance amount would indicate that there is more confidence that the mean value is accurate. This could be used for resource planning. For example, allocation of interceptors may be based on the mean and variance of the damage, as well as the mean and variance of the probability of interception.

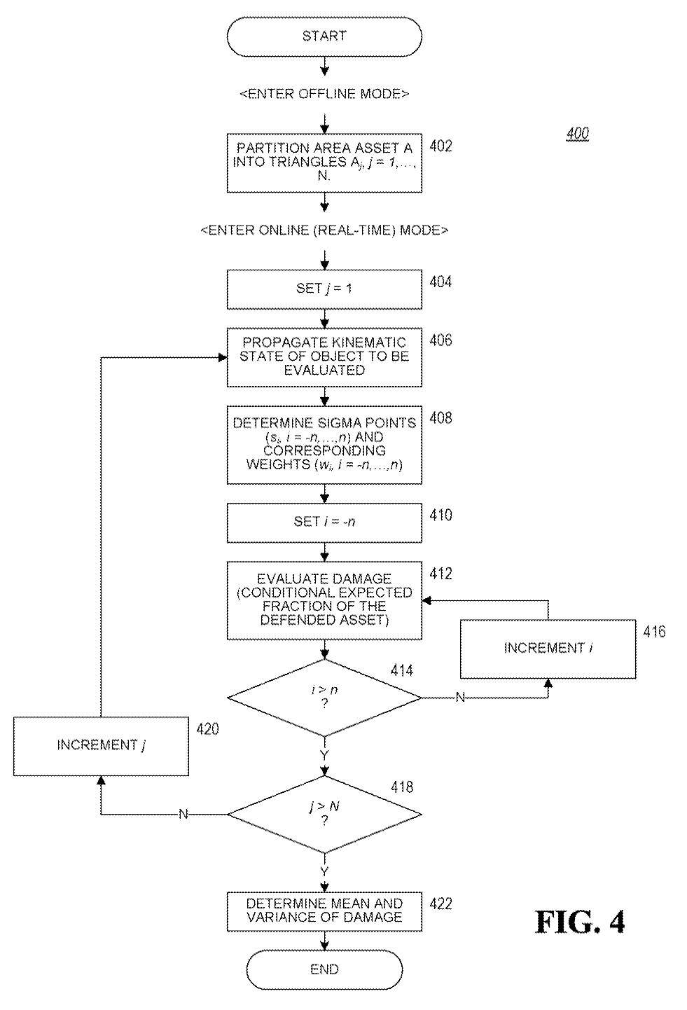

FIG. 4 illustrates a probabilistic process 400 that is an exemplary implementation of the probability determination performed by the real-time object damage and evaluation system 100 for an area asset A, where, in step 402, the area asset A is partitioned into a plurality of geometric shapes A₁, . . . ,A_{N}. In an aspect, each geometric shape is a triangle. In another aspect, with the proper adaptation of the approach described herein, other types of shapes may be used, with shapes not being similar. Further, in the current example, step 402 only has to be performed once and is performed off-line in a non real-time mode. In other approaches, the partitioning of the area asset A may be performed in real-time where defended assets are not pre-determined.

Online, the real-time object damage and evaluation system 100 analyses each triangle Aⱼ before aggregating the results for all triangles in step 402. Thus, in step 404, a counter j is set to 1 to start the analysis of triangle A₁. Operation then continues with step 406.

In step 406, the mean and covariance of the kinematic state of the object to be evaluated is propagated to the predicted ground impact time and these kinematic state parameters are projected onto the horizontal plane tangent to the Earth at the location of the asset. The result is the predicted mean μ and covariance Σ of the kinematic state of the object to be evaluated. Operation then continues to step 408.

In step 408, sigma points sᵢ, i=−n, . . . ,n and the corresponding weights wᵢ, i=−n, . . . ,n are determined.

For each sigma point sᵢ, where each sᵢ represents a ground impact point, a conditional expected fraction of the defended asset that will be destroyed is evaluated. Thus, in step 410, a counter i is set to the value of −n, which will eventually be allowed to run through the value of n. Operation then continues with step 412, where the damage function for the area based on the ground impact point is evaluated.

In step 412, the following damage function is evaluated:

yᵢ=F_{damage}(Aⱼ|sᵢ),

where the function is evaluated by numerical integration:

$${F}_{damage} ( {A}_{j} \vert {s}_{i} ) = \frac{1}{area ( {A}_{j} )} {\int }_{{A}_{j}} d ( ‖ {s}_{i} - {r}_{asset} ‖ ) d {r}_{asset} ,$$

using any method that is specially designed for numerical integration over triangles with respect to a uniform probability distribution. Operation then continues who step 414.

In step 414, it is determined if all sigma points have been processed. In one approach, this is determined by checking the value of i to see if it is larger than the total number (2n+1) of sigma points. If more sigma points need to be processed, then operation continues with step 416, where the counter i is incremented. If all sigma points have been processed, then operation continues with step 418.

In step 418, it is determined if the last triangle has been evaluated by comparing the current state of the counter j to the number N of triangles into which the area asset A has been divided. If so, then operation continues with step 422. Otherwise, operation continues with step 420, where the counter j is incremented for the real-time object damage and evaluation system 100 to evaluate the next triangle of the area asset.

In step 422, the real-time object damage and evaluation system 100 will determine the mean and variance of the probability of damage that the defended asset will suffer if the object to be evaluated is not intercepted.

In the exemplary system provided herein, the real-time object damage and evaluation system 100 not only presents an unbiased estimate of the mean damage value for an object to be evaluated-defended asset pair, but also the variance, which provides a measure of confidence for the mean damage value. Also, the real-time object damage and evaluation system 100 provides physical realism in implementing the damage function and asset region shapes, as opposed to being focused purely on analytical convenience. The real-time object damage and evaluation system 100 is able to perform the evaluation in real-time and without tabulated functions. Using the information, decisions may be made to arrange resources for defending a plurality of assets.

Although one exemplary configuration of the real-time object damage and evaluation system 100 has been described, the real-time object damage and evaluation system 100 could be extended beyond analyzing the damage that an object to be evaluated could do if it is not intercepted. For example, in another exemplary configuration, the real-time object damage and evaluation system 100 could be used to estimate the collateral damage caused by the intercept debris that could result if the object to be evaluated is intercepted; or to estimate the collateral damage done by the interceptor itself if it misses the object to be evaluated and, instead, contacts a defended asset.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

The teachings herein may be incorporated into (e.g., implemented within or performed by) a variety of apparatuses (e.g., devices). Accordingly, one or more aspects taught herein may be incorporated into a computer (e.g., a laptop), a portable communication device, an image processing system (e.g., a radar or photo image processing system), a portable computing device (e.g., a personal data assistant), a phone (e.g., a cellular phone or smart phone), a global positioning system device, or any other suitable device that is configured to perform image processing.

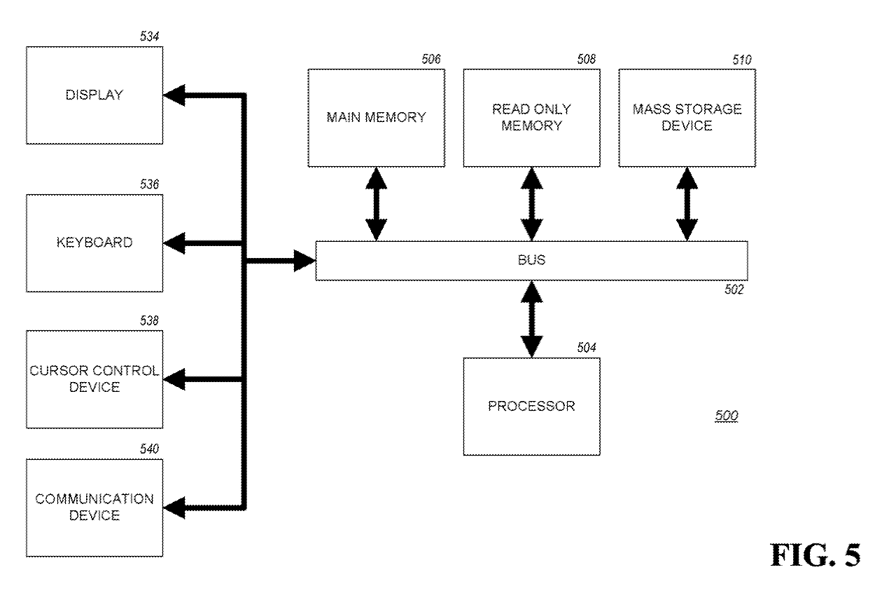

FIG. 5 illustrates an example of a computer system 500 in which certain features of the exemplary real-time object damage and evaluation system 100 may be implemented. Computer system 500 includes a bus 502 for communicating information between the components in computer system 500, and a processor 504 coupled with bus 502 for executing software code, or instructions, and processing information. Computer system 500 further comprises a main memory 506, which may be implemented using random access memory (RAM) and/or other random memory storage device, coupled to bus 502 for storing information and instructions to be executed by processor 504. Main memory 506 also may be used for storing temporary variables or other intermediate information during execution of instructions by processor 504. Computer system 500 also includes a read only memory (ROM) 508 and/or other static storage device coupled to bus 502 for storing static information and instructions for processor 504.

Further, a mass storage device 510, such as a magnetic disk drive and/or a optical disk drive, may be coupled to computer system 500 for storing information and instructions. Computer system 500 can also be coupled via bus 502 to a display device 534, such as a cathode ray tube (CRT) or a liquid crystal display (LCD), for displaying information to a user so that, for example, graphical or textual information may be presented to the user on display device 534. Typically, an alphanumeric input device 536, including alphanumeric and other keys, is coupled to bus 502 for communicating information and/or user commands to processor 504. Another type of user input device shown in the figure is a cursor control device 538, such as a conventional mouse, touch mouse, trackball, track pad or other type of cursor direction key for communicating direction information and command selection to processor 504 and for controlling movement of a cursor on display 534. Various types of input devices, including, but not limited to, the input devices described herein unless otherwise noted, allow the user to provide command or input to computer system 500. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, computer system 500 may optionally include such devices as a video camera, speakers, a sound card, or many other conventional computer peripheral options.

A communication device 540 is also coupled to bus 502 for accessing other computer systems or networked devices, as described below. Communication device 540 may include a modem, a network interface card, or other well-known interface devices, such as those used for interfacing with Ethernet, Token-ring, or other types of networks. In this manner, computer system 500 may be coupled, to a number of other computer systems.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the present disclosure. Thus, the present disclosure is not intended to be limited to the aspects shown herein but is to be accorded the widest scope consistent with the principles and novel features disclosed herein.

What is claimed is:

1. A system for determining a probability of damage by an object to be evaluated comprising:
means for propagating a kinematic state of the object to be evaluated;
means for determining a plurality of probabilities of damage;
means for determining whether each probability of damage is feasible and creating a set of probabilities of feasible damage for each probability of damage; and
means for determining the mean and variance of probability of feasible damage based on the set of probabilities of feasible damage.

2. The system of claim 1, wherein the kinematic state comprises a mean value of the kinematic state of the object to be evaluated.

3. The system of claim 2, further comprising means for projecting the mean and variance of the kinematic state of the object to be evaluated onto a location of contact of the object to be evaluated.

4. The system of claim 1, wherein the kinematic state comprises a covariance value of the kinematic state of the object to be evaluated.

5. The system of claim 1, wherein the means for determining the probabilities of damage includes means for determining a probability of damage for each measured and predicted kinematic state.

6. The system of claim 1, wherein the probability of feasible damage is determined by using a plurality of areas.

7. The system of claim 1, wherein the probability of feasible damage is determined based on a probability that the object to be evaluated will cause significant damage.

8. A method for determining a probability of damage by an object to be evaluated comprising:
propagating a kinematic state of the object to be evaluated;
determining a plurality of probabilities of damage;
determining whether each probability of damage is feasible and creating a set of probabilities of feasible damage for each probability of damage; and
determining the mean and variance of probability of feasible damage based on the set of probabilities of feasible damage.

9. The method of claim 8, wherein the kinematic state comprises a mean value of the kinematic state of the object to be evaluated.

10. The method of claim 9, further comprising projecting the mean and variance of the kinematic state of the object to be evaluated onto a location of contact of the object to be evaluated.

11. The method of claim 8, wherein the kinematic state comprises a covariance value of the kinematic state of the object to be evaluated.

12. The method of claim 8, wherein determining the probabilities of damage includes determining a probability of damage for each portion of the target.

13. The method of claim 8, wherein the probability of feasible damage is determined by using a plurality of areas.

14. The method of claim 8, wherein the probability of feasible damage is determined based on a probability that the object to be evaluated will cause significant damage.

15. A system for real-time determination of damage probability for an object to be evaluated to a target comprising:
an object information storage unit configured to store a kinematic state of the object to be evaluated;
a damage probability determination unit configured to determine a plurality of probabilities of damage for the object to be evaluated; and
a variance and means determination unit configured to determine the mean and variance of probability of damage based on the set of probabilities of damage.

16. The system of claim 15, wherein the variance and means determination unit comprises an unscented transformation unit.

17. The system of claim 15, wherein the kinematic state comprises a mean value of the kinematic state of the object to be evaluated.

18. The system of claim 15, wherein the kinematic state comprises a covariance value of the kinematic state of the object to be evaluated.

19. The system of claim 15, wherein the damage probability determination unit is configured to determine a probability of damage for each portion of the target.

20. The system of claim 15, wherein the probability of damage is determined by using a plurality of areas.

21. The system of claim 15, wherein the probability of feasible damage is determined based on a probability that the object to be evaluated will cause significant damage.
